(19) United States
(12) Patent Application Publication
(10) Pub. No.: US 2025/0390778 A1
(43) Pub. Date: Dec. 25, 2025

(54) Configuring A Quantum Precoder of a Multiple-Input Multiple-Output (MIMO) Device to Optimize Peak to Average Power Ratio (PAPR)

(71) Applicant: Telefonaktiebolaget LM Ericsson (publ), Stockholm (SE)

(72) Inventors: David Bern, Uppsala (SE); Ahsan Javed Awan, Vallentuna (SE); Sairamesh Nammi, Austin, TX (US)

(21) Appl. No.: 19/112,031

(22) PCT Filed: Sep. 19, 2022
(86) PCT No.: PCT/SE2022/050817

§ 371 Date: Mar. 14, 2025

(51) Int. Cl. G06N 10/40; G06N 10/60; H04B 7/0413

(52) U.S. Cl. CPC G06N 10/40; G06N 10/60; H04B 7/0413

(57) ABSTRACT

A Multiple-Input Multiple Output (MIMO) device (200) determines a minimum output vector produced by a quadratic unconstrained minimization function. The quadratic unconstrained minimization function comprises a peak power factor, an average power factor, an Error Vector Magnitude (EVM) constraint factor for meeting an EVM constraint, and a plurality of penalty coefficients that penalizes outcomes that violate the EVM constraint. The MIMO device (200) minimizes the peak power factor and maximizes the average power factor. The minimizing and maximizing are each performed within the EVM constraint. The MIMO device (200) derives a Quantum Unconstrained Binary Optimization (QUBO) from the minimum output vector. The MIMO device (200) then configures the quantum precoder (210) to generate a configuration of qubits that are representative of a precoding vector that meets the EVM constraint and minimizes Peak to Average Power Ratio (PAPR) of a transmission from the MIMO device (200). The configuring comprises embedding the QUBO on the quantum precoder (210).

### TECHNICAL FIELD

The present disclosure is generally directed to the technical field of wireless communication and, more particularly, to the application of quantum computing to determine an appropriate precoding vector for use in wireless communication via a Multiple-Input Multiple-Output (MIMO) device.

### BACKGROUND

MIMO systems can significantly increase the throughput of wireless systems. 5G technology employs MIMO systems with many antennas called massive MIMO systems. The setup of a MIMO device can often be expressed in terms of (Nₜ, Nᵣ) antennas, where Nₜ denotes the number of transmit antennas and Nᵣ denotes the number of receive antennas. In massive MIMO, the peak data rate scales linearly with a factor of Nₜ compared to single antenna systems in a rich scattering environment.

The Orthogonal Frequency Division Multiplexing (OFDM) waveform is used for both downlink and uplink transmissions in many systems. In an OFDM system, the transmit signal can have high peak power values in the time domain because many subcarrier components are added via an Inverse Fast Fourier Transform (IFFT) operation. Therefore, OFDM symbols are known to have
a high peak-to-average power ratio (PAPR) compared with single-carrier systems. The high PAPR pushes the signal to the nonlinear region of High-Power Amplifiers (HPAs) and imposes in-band and out-of-band distortion. This in-band and out-of-band distortion can respectively deteriorate the system performance in terms of Error Vector Magnitude (EVM) and Adjacent Channel Leakage Ratio (ACLR) in the same cell as well as in neighboring cells.

The Third Generation Partnership Project (3GPP) specifies EVM requirements for different modulation schemes. High PAPR is one of the most detrimental aspects of OFDM transmission, as it decreases the Signal-to-Quantization Noise Ratio (SQNR) of Analog-to-Digital Converters (ADCs) and Digital-to-Analog Converters (DACs) because of the low efficiency of the HPAs in the transmitter.

### SUMMARY

Embodiments of the present disclosure generally relate to configuring a quantum precoder of a MIMO device to generate a precoding matrix that optimizes PAPR within an EVM constraint. Particular embodiments use classical computing approaches to obtain an appropriate QUBO that is embedded on the quantum precoder via quantum annealing. The quantum precoder generates a configuration of qubits that represents the optimal precoding vector.

Particular embodiments include a method of configuring a quantum precoder of a MIMO device. The method comprises determining a minimum output vector produced by a quadratic unconstrained minimization function. The quadratic unconstrained minimization function comprises a peak power factor based on a max norm of a first input vector of complex elements. The quadratic unconstrained minimization function further comprises an average power factor based on an L2-norm of a second input vector of complex elements. The quadratic unconstrained minimization function further comprises an EVM constraint factor based on an L2-norm of a quadratic formula for meeting an EVM constraint given a signal vector, a noise vector, and a channel matrix. The quadratic unconstrained minimization function further comprises a plurality of penalty coefficients that penalize the minimum output vector when the minimum output vector violates the EVM constraint. The method further comprises minimizing the peak power factor and maximizing the average power factor. The minimizing and maximizing are each performed within the EVM constraint. The method further comprises deriving a Quantum Unconstrained Binary Optimization (QUBO) from the minimum output vector. The method further comprises configuring the quantum precoder to generate a configuration of qubits that are representative of a precoding vector that meets the EVM constraint and minimizes PAPR of a transmission from the MIMO device. The configuring comprises embedding the QUBO on the quantum precoder.

In some embodiments, minimizing the peak power factor comprises determining a maximum real value that is lesser than each element of the first input vector of complex elements and increasing the maximum real value to penalize values of the peak power factor that are less than each element of the first input vector.

In some embodiments, maximizing the average power factor comprises determining a minimum real value based on an L2 norm of the second input vector.

In some embodiments, deriving the QUBO from the minimum output vector comprises, responsive to minimizing the peak power factor and maximizing the average power factor, introducing a further penalty coefficient to the quadratic unconstrained minimization function. The further penalty coefficient penalizes values of the peak power factor that introduce one or more terms of higher order than quadratic.

In some embodiments, the quantum precoder is comprised within a general gate model quantum computing device of the MIMO device.

In some embodiments, embedding the QUBO on the quantum precoder comprises embedding the QUBO through quantum annealing. In other embodiments, generating the configuration of qubits comprises processing the QUBO using a Quantum Approximate Optimization Algorithm (QAOA) to determine the configuration of qubits.

In some embodiments, the method further comprises reading the configuration of qubits out of the quantum precoder and determining the precoding vector by translating the qubits to real values and converting the real values to respective complex elements of the precoding vector.

In some embodiments, the method further comprises transmitting the transmission via an antenna array of the MIMO device using the precoding vector.

In some embodiments, the plurality of penalty coefficients comprises, for each of the peak power factor, the average power factor, and the EVM constraint factor, a respective penalty coefficient such that each of the peak power factor, average power factor, and EVM constraint is individually tunable.

In some embodiments, the method further comprises obtaining the quadratic unconstrained minimization function by applying a quadratic loss function to a constrained PAPR objective function.

Other embodiments include a MIMO device comprising processing circuitry and memory circuitry. The memory circuitry stores instructions executable by the processing circuitry whereby the MIMO device is configured to determine a minimum output vector produced by a quadratic unconstrained minimization function. The quadratic unconstrained minimization function comprises a peak power factor based on a max norm of a first input vector of complex elements. The quadratic unconstrained minimization function further comprises an average power factor based on an L2-norm of a second input vector of complex elements. The quadratic unconstrained minimization function further comprises an EVM constraint factor based on an L2-norm of a quadratic formula for meeting an EVM constraint given a signal vector, a noise vector, and a channel matrix. The quadratic unconstrained minimization function further comprises a plurality of penalty coefficients that penalize the minimum output vector when the minimum output vector violates the EVM constraint. The MIMO device is further configured to minimize the peak power factor and maximize the average power factor. The minimizing and maximizing are each performed within the EVM constraint. The MIMO device is further configured to derive a QUBO from the minimum output vector. The MIMO device is further configured to configure the quantum precoder to generate a configuration of qubits that are representative of a precoding vector that meets the EVM constraint and minimizes PAPR of a transmission from the MIMO device. To configure the quantum precoder, the MIMO device is configured to embed the QUBO on the quantum precoder.

In some embodiments, the MIMO device is further configured to perform any of the methods described above.

Other embodiments include a computer program, comprising instructions which, when executed on processing circuitry of a MIMO device, cause the processing circuitry to carry out any of the methods described above.

Yet other embodiments include a carrier containing said computer program. The carrier is one of an electronic signal, optical signal, radio signal, or computer readable storage medium.

### BRIEF DESCRIPTION OF THE DRAWINGS

Aspects of the present disclosure are illustrated by way of example and are not limited by the accompanying figures with like references indicating like elements. In general, the use of a reference numeral should be regarded as referring to the depicted subject matter according to one or more embodiments, whereas discussion of a specific instance of an illustrated element will append a letter designation thereto (e.g., discussion of a computing device 110, generally, as opposed to discussion of particular instances of computing devices 110a, 110b).

FIG. 1 is a schematic diagram illustrating an example communication system, according to one or more embodiments of the present disclosure.

FIG. 2 is a schematic diagram illustrating an example MIMO device communicating over a radio channel with a plurality of user equipment (UEs), according to one or more embodiments of the present disclosure.

FIG. 3 is a flow diagram illustrating an example process implemented by a MIMO device, according to one or more embodiments of the present disclosure.

FIG. 4 is a graph illustrating error counts for different amounts of normalized error observed experimentally using Simulated Annealing and Quantum Annealing upon testing one or more embodiments of the present disclosure.

FIG. 5 is a table illustrating example EVM constraints as may be required under 3GPP standards.

FIG. 6 is a table illustrating configurations of binary variables in accordance with one or more embodiments of the present disclosure.

FIG. 7 is a graph illustrating quadratization error for different amounts of penalty observed experimentally upon testing one or more embodiments of the present disclosure.

FIG. 8 is a graph illustrating error counts for different amounts of normalized error observed experimentally using Simulated Annealing and Quantum Annealing upon testing one or more embodiments of the present disclosure.

FIG. 9 is a table illustrating pairs of penalty terms found upon performing a grid-search given different amounts of binary variables used to approximate values of a given objective function, according to one or more embodiments of the present disclosure.

FIG. 10 is a graph illustrating the distribution of PAPR and EVM values obtained as a result of testing performance of one or more embodiments of the present disclosure.

FIG. 11 is a flow diagram illustrating an example method implemented by a MIMO device, according to one or more embodiments of the present disclosure.

FIG. 12 is a schematic diagram illustrating an example MIMO device, according to one or more embodiments of the present disclosure.

### DETAILED DESCRIPTION

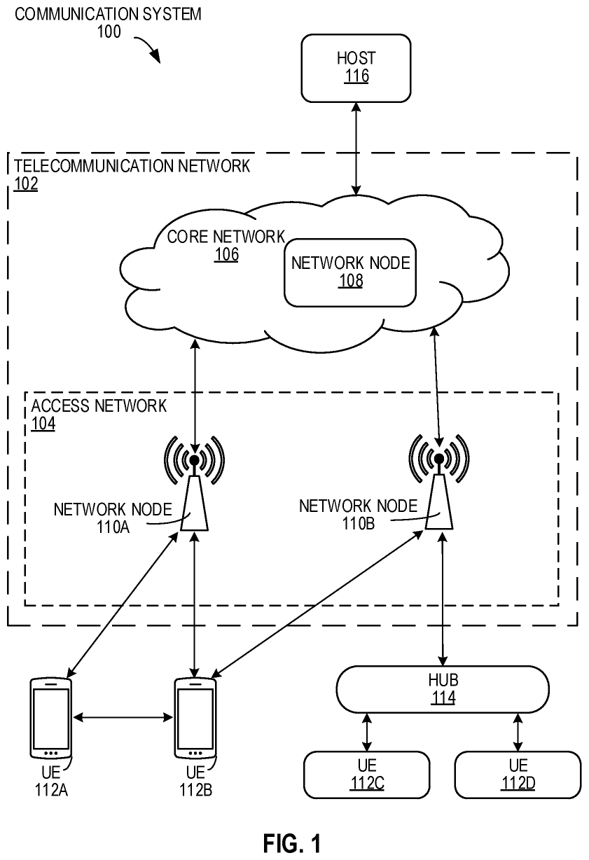

FIG. 1 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b, or any other similar 3GPP access node or non-3GPP access point. The network nodes 110 facilitate direct or indirect connection of user equipment (UE), such as by connecting UEs 112a, 112b, 112c, and 112d to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102 and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

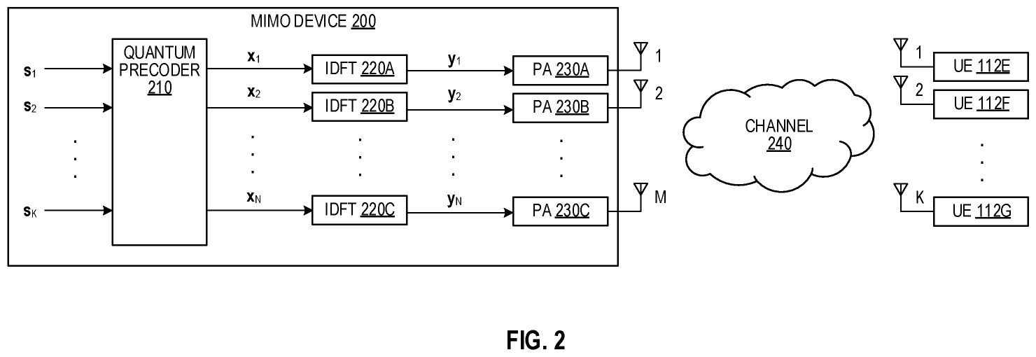

Any of the network nodes 110 and UEs 112 may be a MIMO device. FIG. 2 illustrates an example of a MIMO device 200 (e.g., a network node 110) communicating with a plurality of UEs 112e-g over a radio channel 240 in greater detail. Embodiments of the present disclosure are generally directed to improving PAPR in MIMO devices 200 through the use of a quantum precoder 210 that generates, for a given symbol vector s, an appropriate precoding vector x for use in transmitting via a MIMO antenna array. However, as will be discussed in further detail below, modern quantum devices have certain limitations that make the use of classical processing approaches to precoding impossible or impractical.

As shown in the example of FIG. 2, the precoding vector x generated by the quantum precoder 210 is provided to a plurality of Inverse Discrete Fourier Transform (IDFT) modulators 220a-c, which provide modulated symbols y to a plurality of power amplifiers 230a-c (e.g., HPAs) for transmission over respective antennas to the UEs 112e-g. As will be discussed in greater detail below, the techniques, devices, and systems described herein provide significant advantages over existing techniques for improving PAPR.

For example, one known technique for avoiding large amplitude peaks is to use a large power backoff. Power backoff in an amplifier 230 is a power level below the saturation point at which the amplifier 230 will continue to operate in the linear region even if there is a slight increase in the input power level. However, it is very inefficient to run HPAs with a considerable power backoff yet still maintain the same cell coverage.

Consequently, many Crest Factor Reduction (CFR) techniques have been proposed in the existing literature. Clipping and filtering is a well-known conventional method that clips the peaks of the time domain signal and filters the out-of-band emissions several times before sending the signal through the HPAs.

Another approach for massive CFR is to project the clipped error onto the null space of the channel. The null space of the channel matrix H, denoted N (H), is the set of all n-dimensional column vectors x such that Hx=0. In network deployments in which uplink and downlink are in the same band (e.g., in Time Domain Duplex (TDD) systems) a UE 112 transmits pilot signals in the uplink and exploits the reciprocity between uplink and downlink to identify good downlink beams. For the reciprocity-based precoding, the channel matrix H is known at the transmitter. Hence, the clipped error is nulled out while the PAPR is reduced at the same time.

Finding an optimal precoded vector x that minimizes PAPR within an EVM constraint is a non-convex optimization problem written as:

$${argmin}_{x} \frac{{‖ {F}^{H} x ‖}_{∞}^{2}}{{‖ x ‖}_{2}^{2}} , such that Hx + n = s \qquad ( Eq . 1 )$$

where F^{H}T∈ [symbol] ^{MN} is written as F^{H} in Equation 1, above, for brevity. T is the permutation matrix that maps elements of vector x to the relevant antennas. F^{H} is the IFFT of symbols to be transmitted. H∈ [symbol] ^{MN} is the channel matrix and s∈ [symbol] ^{N} is data vector fed to the precoder, N denotes the number of sub-carriers.

Non-convex optimization problems are generally computationally difficult to solve. Such problems may, for example, have multiple feasible solution domains and multiple locally optimal solutions within each domain. It can take significant processing time that an optimal solution is the global optimum as opposed to merely a local optimum, for example. Thus, embodiments of the present disclosure propose to convert the non-convex optimization problem of Equation 1 to a convex problem.

A traditional approach that may be applied to convert the objective function from non-convex to convex is to minimize the maximum amplitude of the time domain signal using a process known as Convex Reduction of Amplitude (CRAM). The minimum in a CRAM approach may be obtained by two methods, namely Alternating Direction Method of Multipliers (ADMM) and Projected Gradient Descent Method (PGDM). The infinity-norm is approximated with a smooth log barrier function. These methods iteratively search for the optimal distortion signal that minimizes the PAPR and achieves zero EVM when the channel is completely known at the base station.

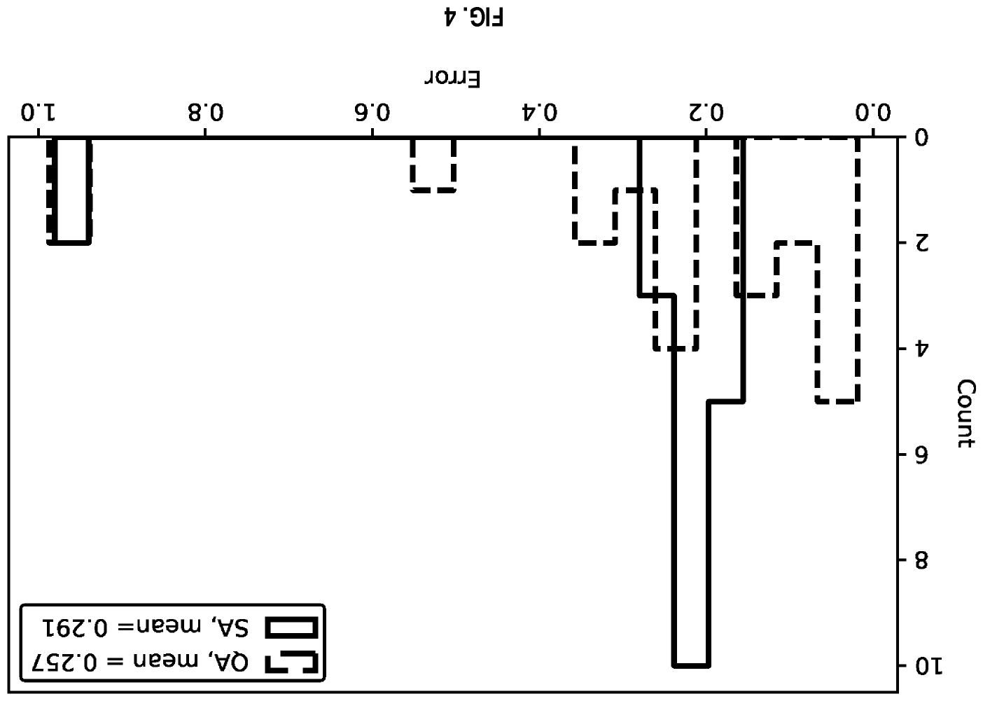

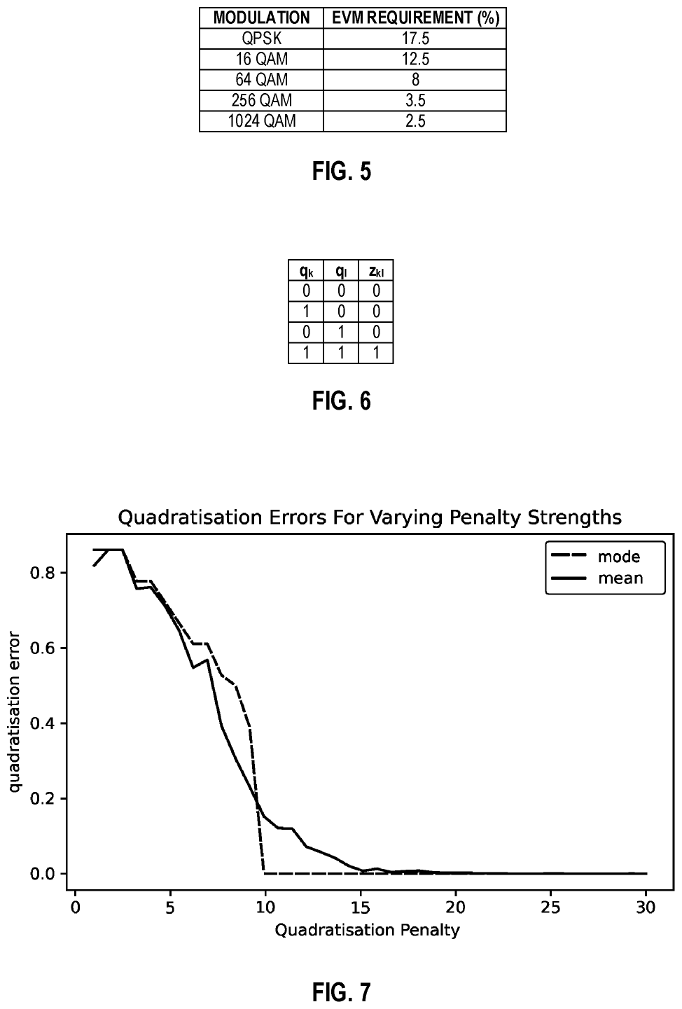

However, in practice, traditional approaches to precoding vector determination are often inadequate for use in modern communication systems. For example, known clipping and filtering techniques suffer from in-band emission, which results in a high EVM. Accordingly, known clipping and filtering techniques are unable to meet stringent EVM requirements (such as those imposed by 3GPP, see the table illustrated in FIG. 5), particularly for higher modulation schemes with heavy clipping.

Moreover, CRAM reduction-based schemes are iterative and involve multiple IFFT and Fast Fourier Transform (FFT) operations due to clipping in the time-domain. These operations introduce significant latency.

In view of these significant deficiencies in known techniques, embodiments of the present disclosure provide a latency-efficient solution for optimizing PAPR when under an EVM constraint. For example, particular embodiments formulate the non-convex PAPR optimization problem with EVM constraint in Quadratic Unconstrained Binary Optimization (QUBO) form, which is embedded on a quantum computer (e.g., quantum precoder 210) to get an optimal precoded vector. To do so, PAPR is expressed as multi-objective function comprising a difference between the max-norm of a time-domain signal and the L2-norm of the precoded vector. The EVM constraint is also expressed as an L2-norm. Max norm is approximated as a linear program where a real variable is minimized such that the square of the magnitude of each complex element of the vector F^{H}x is less than that real variable. These are combined into a unconstrainted minimization problem scaled with appropriate penalties. The binary expression of max-norm approximation results in higher order terms, which are quadrated by introducing auxiliary variables and penalties that suppress the configurations of binary variables that result in higher order terms. Each binary variable is mapped to a qubit, and the QUBO formulation is solved, e.g., using quantum annealing, simulated annealing, or a Quantum Approximate Optimization Algorithm (QAOA). The resulting configuration of the qubits at the end is processed classically to compute the desired precoded vector.

Other example techniques for configuring a quantum precoder 210 that include one or more of the aspects described above will be discussed in greater detail below. That said, it is notable that, advantageously, the devised QUBO formulation of the max norm in various embodiments described herein is generic and can be used to solve the infinity-norm efficiently on a quantum computer. Further, a quantum-based solution for PAPR optimization with an EVM constraint does not require multiple IFFT/FFT operations across multiple iterations, thereby providing a solution that is latency-efficient.

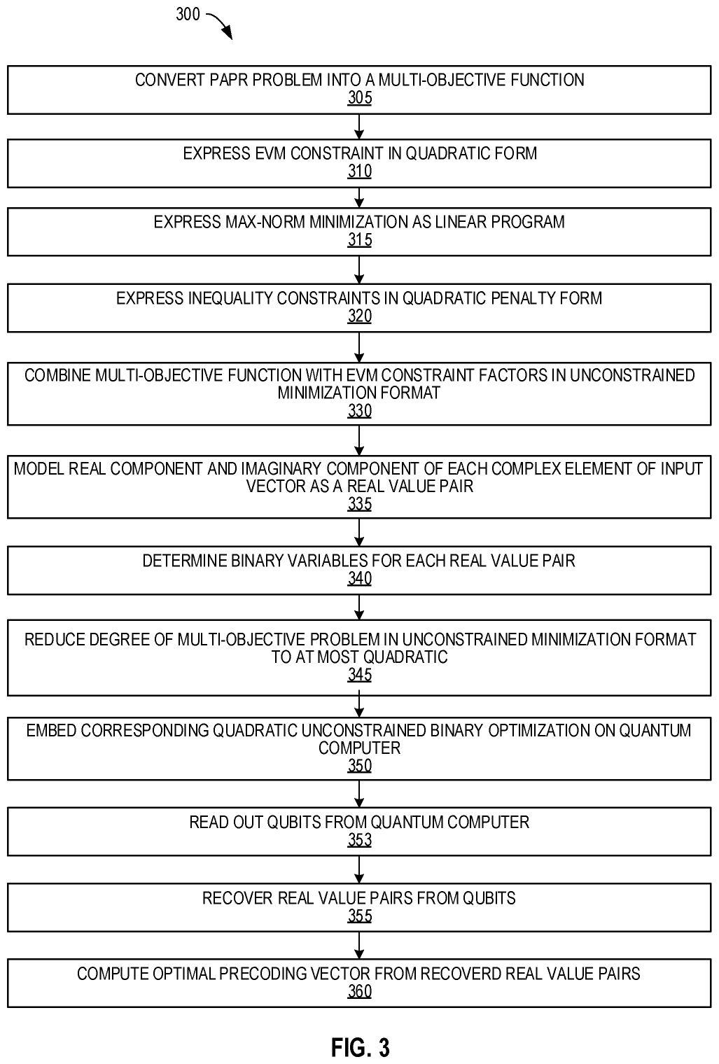

An example process 300 for obtaining a precoding vector implemented by a computing device (e.g., a MIMO device 200) is illustrated in FIG. 3. In view of the above, the PAPR objective function may be expressed as a ratio between a peak power factor and an average power factor, e.g., as shown in Equation 2.

$$\frac{{‖ {F}^{H} x ‖}_{∞}^{2}}{{‖ x ‖}_{2}^{2}} \qquad ( Eq . 2 )$$

As shown in Equation 2, the peak power factor is expressed as a max norm, whereas the average power factor is expressed as an L2 norm. Generally, PAPR optimization can be achieved by minimizing the max norm and maximizing the L2 norm. As noted above (and as will be discussed in greater detail below), the use of the max norm in many of the functions discussed herein may yield significant benefits that are well-suited for a quantum computing environment.

As part of the process 300, the PAPR objective function is converted into a multi-objective function (block 305), e.g., as shown in Equation 3. In this example, to convert the objective function into a multi-objective function, the objective function is converted from a ratio of the peak power factor to the average power factor (as shown in Equation 2) into a difference between the peak power factor and the average power factor.

$${‖ {F}^{H} x ‖}_{∞}^{2} - {‖ x ‖}_{2}^{2} \qquad ( Eq . 3 )$$

As discussed above, the MIMO device 200 is subject to an EVM constraint. Accordingly, the configuration provided to the quantum precoder 210 is determined such that this EVM constraint is considered. As part of the process 300, the EVM constraint is expressed in a quadratic form (block 310), e.g., such that it can be readily added later to the PAPR objective function.

For example, achieving the EVM constraint Hx+n=s is equivalent to requiring that:

$${( Hx + n - s )}^{2} = {‖ Hx - {s}^{′} ‖}_{2}^{2} , {s}^{′} := s - n \qquad ( Eq . 4 )$$

Given that optimization problem being addressed involves an objective function subject to a constraint, it would be advantageous for the problem to be solved by linear programming as opposed to nonlinear programming. Linear programming is a mathematical modeling technique in which a linear function is maximized or minimized when subjected to one or more constraints. In contrast, nonlinear programming is a technique that solves an optimization problem in which a constraint and/or objective function is nonlinear. Nonlinear components generally behave less predictably than linear components. Accordingly, embodiments of the present disclosure express the max-norm minimization of F^{H}x (expressed as y having a size L in the following equations) as a linear program, e.g., as shown in Equation 5 in which u is a real-valued minimization variable (block 315) and n is an integer number from 1 to L, where L is number of elements in the vector y, i.e. its size. In this example process 300, μ is the objective function, which can be expressed as:

$$minimize μ s . t . {\vert {y}_{n} \vert}^{2} \leq μ ∀ n = 1 , … , L , for some μ \geq 0 \qquad ( Eq . 5 )$$

Although such steps may be used to increase the predictability of the likely solution to the optimization problem, modern quantum devices may nonetheless be unable to accept constraints. Therefore, embodiments of the present disclosure apply a quadratic penalty such that terms in violation of the constraint are magnified. By penalizing constraint violations by making terms larger, minimization processing is forced toward a solution space that is more feasible for the constrained problem. Although other penalty functions may alternatively be used according to other embodiments, the use of a quadratic penalty is a simple way to implement the penalty function. Expressing the inequality constraints in quadratic penalty form (block 320), the relevant portion of Equation 5 may be expressed as:

$${\vert {y}_{n} \vert}^{2} \leq μ ⇔ {( {\vert {y}_{n} \vert}^{2} + {k}_{n} - μ )}^{2} , with {k}_{n} \geq 0. \qquad ( Eq . 6 )$$

Correspondingly, when substituted back into Equation 5 described above, the following is obtained:

$$minimize μ - {‖ x ‖}_{2}^{2} s . t . {( {\vert {y}_{n} \vert}^{2} + {k}_{n} - μ )}^{2} , ∀ n = 1 , … , L . \qquad ( Eq . 7 )$$

Now that the EVM constraint is expressed in quadratic penalty form, the EVM constraint may be combined with the multi-objective function in an unconstrained minimization format (block 330), thereby overcoming the aforementioned technical limitations of modern quantum devices in accepting constrained optimization problems. In this example, the resulting combination is:

$$min \{ μ - {‖ x ‖}_{2}^{2} + {γ}_{1} {\sum }_{n = 0}^{ZL} {( {\vert {y}_{n} \vert}^{2} + k - μ )}^{2} + {γ}_{2} {‖ Hx - {s}^{′} ‖}_{2}^{2} \} \qquad ( Eq . 8 )$$

In Equation 8, the penalty parameters are expressed as γ_{1,2}, such that solutions violating the constraints are appropriately penalized.

The elements of the input vector x may be a vector of complex elements. Complex numbers can be thought of as including a real component and an imaginary component. Thus, complex numbers can be expressed in the form a+bi, in which a is a real number representing the real component, i is an imaginary unit (i.e., the square root of −1), and b is a real number that, when multiplied by the imaginary unit, represents the imaginary component. Stated differently, a complex element can be represented by a pair of real values, one of which represents the real component of the complex element and the other of which represents the imaginary component.

It is a goal of the quantum precoder 210 to produce a configuration of binary values that reveal the optimal precoding vector x such that PAPR is minimized while meeting the EVM constraint. In furtherance of this objective, embodiments of the present disclosure model the real component and the imaginary component of each complex element the input vector as a real value pair (block 335). The following transformations, for example, are a way that such may be accomplished:

$$x \to \tilde{x} = [ \begin{matrix}Re ( x ) \\ Im ( x )\end{matrix} ] \qquad ( Eq . 9 )$$

$$y \to \tilde{y} = {\tilde{F}}^{H} \tilde{x} = [ \begin{matrix}Re ( {F}^{H} ) & - Im ( {F}^{H} ) \\ Im ( {F}^{H} ) & Re ( {F}^{H} )\end{matrix} ] \tilde{x} \qquad ( Eq . 10 )$$

$$H \to \tilde{H} = [ \begin{matrix}Re ( H ) & - Im ( H ) \\ Im ( H ) & Re ( H )\end{matrix} ] \qquad ( Eq . 11 )$$

Having modeled the real and imaginary components of each complex element as a real value pair, embodiments then determine a set of binary variables for each real value pair (block 340). The number of binary variables to be determined depends on a user-set range for the values of the real value pair and will correspond to the number of qubits to be encoded by the quantum precoder 210. Accordingly, for each real component or imaginary component, the binary variable q_{k,j} may be the k-th binary variable approximating the j-th complex element of the input vector. Accordingly, the binary variables qₖ for each aⱼ, bⱼ in the j-th complex element of the input vector (i.e., xⱼ) may, for example, be approximated according to the following equation, based on the user-set range [−dⱼ, 2_{c}−dⱼ) for real value pairs:

$${a}_{j} , {b}_{j} = {c}_{j} {\sum }_{k = 0}^{R - 1} {2}^{- k} {q}_{k , j} - {d}_{j} ∈ [ - {d}_{j} , 2 {c}_{j} - {d}_{j} ) \qquad ( Eq . 12 )$$

All of the values of kₙ discussed above may be approximated for μ in the same way, with corresponding user-set ranges.

Despite these steps, the multi-objective function with the EVM constraint in unconstrained minimization format is still not yet ready to be embedded in the quantum precoder. This is because the term ( [symbol] |²+kₙ−μ)² of Equation 8 introduces terms that are higher order than quadratic when the binary variables qₖ are incorporated. As noted above, current quantum devices are unable to handle more than quadratic problems (or linear combinations thereof). Therefore, embodiments of the present disclosure reduce the degree of the multi-objective problem in unconstrained minimization format to, at most, quadratic (block 345). This reduction may be performed, e.g., by introducing an auxiliary variable z and a corresponding penalty parameter M that may differ for each penalty as follows:

$${q}_{k} {q}_{l} \to {z}_{kl} + M ( {q}_{k} {q}_{l} - 2 {q}_{k} {z}_{kl} - 2 {q}_{l} {z}_{kl} + 3 {z}_{kl} ) \qquad ( Eq . 13 )$$

In this way, binary value combinations that introduce higher order terms are penalized and effectively eliminated, thereby reducing the problem to a quadratic. That is, the logical and of the variables is enforced through the strength of M.

Having been reduced to quadratic, the multi-objective problem in unconstrained minimization format is converted into a QUBO that the quantum precoder 210 can accept. Accordingly, embodiments of the present disclosure include embedding the QUBO on the quantum precoder 210 (block 350), e.g., using quantum annealing, simulated annealing, quantum approximate optimization, or other technique as appropriate.

After the QUBO has been embedded, the binary configuration of qubits corresponding to each aⱼ, bⱼ, kₙ, and μ are read out from the quantum precoder 210 (block 353). The binary configurations may then be fed into Equation 12 to recover their corresponding real values (block 355). These real values may then be sent back through the inverse of the transformations of Equations 9-11 to obtain the optimal precoding vector x of complex elements that minimizes PAPR while meeting the EVM constraint (block 360).

The process 300 described above is one particular example in which the optimal precoding vector may be obtained. Other embodiments may vary in a variety of ways. That said, of the various principles discussed above, the use of the max norm provides plays a significant role in many embodiments.

Consider the results obtained in the following example. Let v be a test vector with a known maximum as follows, for a randomly selected element j:

$${v}_{j} = max \{ v \} = 2 + 2 i \qquad ( Eq . 14 )$$

Further take:

$${v}_{m} = 1 + i , ∀ m \neq j \qquad ( Eq . 15 )$$

Under such conditions, μ≈max{v}, up to the decimal accuracy of the binary approximation of μ, is obtained by successfully minimizing:

$$μ + {γ}_{1} {{\sum }_{n = 1}}^{\text{?} = L} {( {\vert \text{?} \vert}^{2} + {k}_{n} - μ )}^{2} \qquad ( Eq . 16 )$$

$$\text{?} \text{indicates text missing or illegible when filed}$$

Simulated Annealing (SA) and Quantum Annealing (QA) were both experimentally performed to find the global minimum of Equation 16 for 20 instances each in which j was random in every instance. In each instance, 100 anneals were performed and only the lowest energy sample considered. The errors of the results are illustrated in the histogram of FIG. 4. The horizontal axis of the histogram is the error, |vⱼ−μ|, normalized to 1. The vertical axis of the histogram marks the error count. The optimal penalty was found to be at around γ₁=60, although this varies depending on the magnitude of v and the user set ranges.

From this preliminary experiment, QA shows competitive promise with SA, having lower mean error as well as lower smallest error. Unlike SA, the QA performance can possibly be further optimized by parameters inherent only to QA (such as different embedding or chain strength), as well as improved hardware/software in the future. Although only QA and SA were experimentally verified, other quantum-enabled approaches (e.g., QAOA) may also be used according to other embodiments.

Although quadratization was not required in this example, for the more general case, quadratization is needed, e.g., to reformulate the objective function by introducing a set of auxiliary binary variable which can be optimized using quadratic optimization techniques.

The linear programming formulation of the max norm introduces higher order terms in its constraints (e.g., in process 300 in the binary variables qₖ). Thus, to quadraticize, for all higher order terms in the expression, qₖqₗ is replaced by an auxiliary binary variable zₖₗ with the penalty:

$${q}_{k} {q}_{l} \to {z}_{kl} + M ( {q}_{k} {q}_{l} - 2 {q}_{k} {z}_{kl} - 2 {q}_{l} {z}_{kl} + 3 {z}_{kl} ) , M ∈ R \qquad ( Eq . 17 )$$

If M is large enough, zₖₗ≡qₖqₗ should hold throughout the anneal, meaning the final configurations of binary variables should adhere to the table of FIG. 6.

The annealing may be scored according to whether quadratization was respected through use of a scoring function, such as the following:

$${S}_{kl} = \{ \begin{matrix}0 , {z}_{kl} = {q}_{k} {q}_{l} \\ 1 , {z}_{kl} \neq {q}_{k} {q}_{τ}\end{matrix} \qquad ( Eq . 18 )$$

Correspondingly, quadratization error may be defined as the following, with “#” representing “number of”:

$$quad . error = \frac{\# ( S = 0 )}{\# S} \qquad ( Eq . 19 )$$

Using this method of determining quadratization error, a random vector u was experimentally modeled in which uⱼ∈[−2+ϵⱼ, 2+ϵⱼ) by taking ϵⱼ∈[−0.5, 0.5] at random. Running this vector through the max norm minimization as discussed above, some terms are forced to be quadraticized. Running the max norm minimization of u, the penalty M is increased for each new set of anneals. In this particular example, there were 100 anneals for every new value of M. The mean and median quadratization error for each M, from 1 to 30, is illustrated in the graph of FIG. 7. Notably, as M increases, the error decreases to zero. As shown, in this example, quadratization is respected once M reaches 20.

As noted above, the EVM constraint is a linear system which may be expressed as Hx=s−n. A classical solver was experimentally used to determine a precoding solution provided a given message vector, a given noise vector, and a random matrix. The random matrix was:

$$H = [ \begin{matrix}2 + i & 2 + i \\ 2 + i & 2\end{matrix} ] \qquad ( Eq . 20 )$$

The given message vector was:

$$s = {[ - 3 + i , 1 - i ]}^{T} \qquad ( Eq . 21 )$$

The given noise vector was:

$$n = {[ - 0.1 + 0.2 i , 0.5 i ]}^{T} \qquad ( Eq . 22 )$$

Given these inputs, the classical solver determined the solution to be:

$$\text{?} = {[ - 3.3 - 3 i , 2.3 + 3.9 i ]}^{T} \qquad ( Eq . 23 )$$

$$\text{?} \text{indicates text missing or illegible when filed}$$

The error may be derived from the vector x obtained from annealing, e.g., according to:

$$error = {‖ \text{?} - x ‖}_{2} \qquad ( Eq . 24 )$$

$$\text{?} \text{indicates text missing or illegible when filed}$$

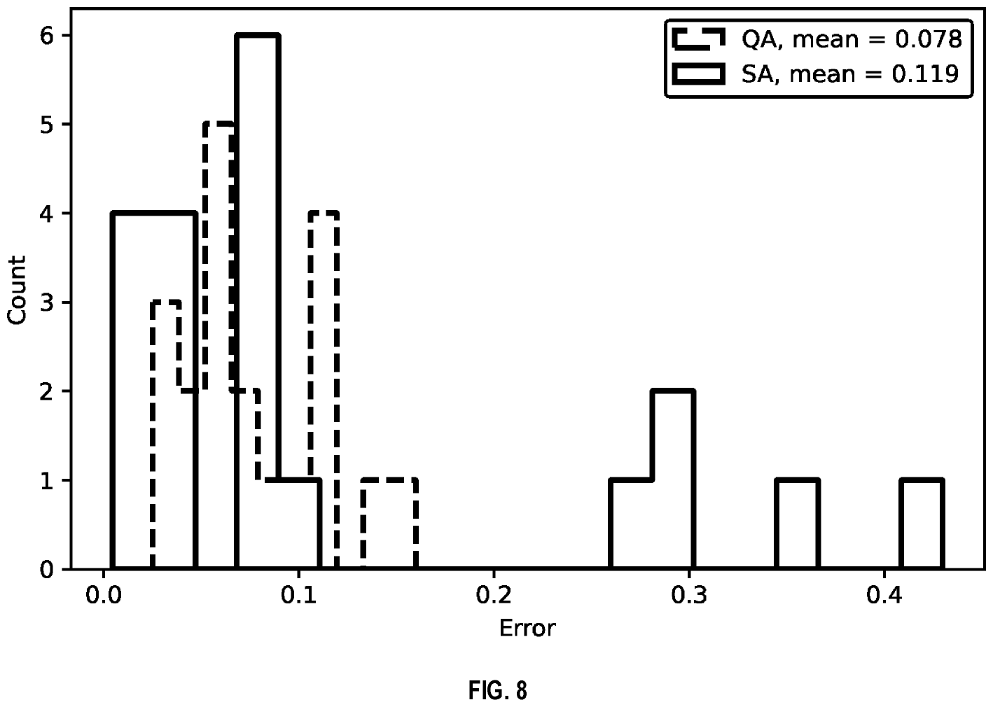

Twenty instances of 1000 anneals were experimentally performed and the samples with the lowest energy were chosen. The normalized errors of the results obtained from this experiment using both SA and QA are illustrated in the histogram of FIG. 8. Notably, the QA results are once again competitive with classical SA and have a lower mean error.

Due to the limited size of the QA, a theoretical 2×2 MIMO device was used as a proof of concept to experimentally demonstrate the viability of the techniques discussed herein. In this example, N is set equal to 1 so that the problem can fit onto the quantum annealer, which means there is only 1 sub-carrier frequency in the OFDM. The following message vector s and channel state matrix H were randomly picked for this experiment.

$$s = ( \begin{matrix}3 + 3 i \\ 3 - 3 i\end{matrix} ) \qquad ( Eq . 25 )$$

$$H = ( \begin{matrix}1 + i & 1 + i \\ 2 + 2 i & 2\end{matrix} ) \qquad ( Eq . 26 )$$

Further, n is set to be the zero vector for simplicity and to quantify EVM easier. In this setting, the IDFT matrix for the entire MIMO device is the identify matrix:

$${F}^{H} = ( \begin{matrix}1 & 0 \\ 0 & 1\end{matrix} ) \qquad ( Eq . 27 )$$

For this problem, the PAPR takes the following form, wherein xₘ is the maximum value:

$$\frac{{‖ {F}^{H} x ‖}_{∞}^{2}}{{‖ x ‖}_{2}^{2}} = \frac{{‖ x ‖}_{∞}^{2}}{{‖ x ‖}_{2}^{2}} = \frac{{\vert {x}_{m} \vert}^{2}}{{\sum }_{i} {\vert {x}_{i} \vert}^{2}} = {( 1 + {\sum }_{i \neq m} \frac{{\vert {x}_{i} \vert}^{2}}{{\vert {x}_{m} \vert}^{2}} )}^{- 1} \leq 1 \qquad ( Eq . 28 )$$

While PAPR is bigger than 1 in massive MIMO systems, this problem setting still demonstrates the viability of the overall structure of the problem.

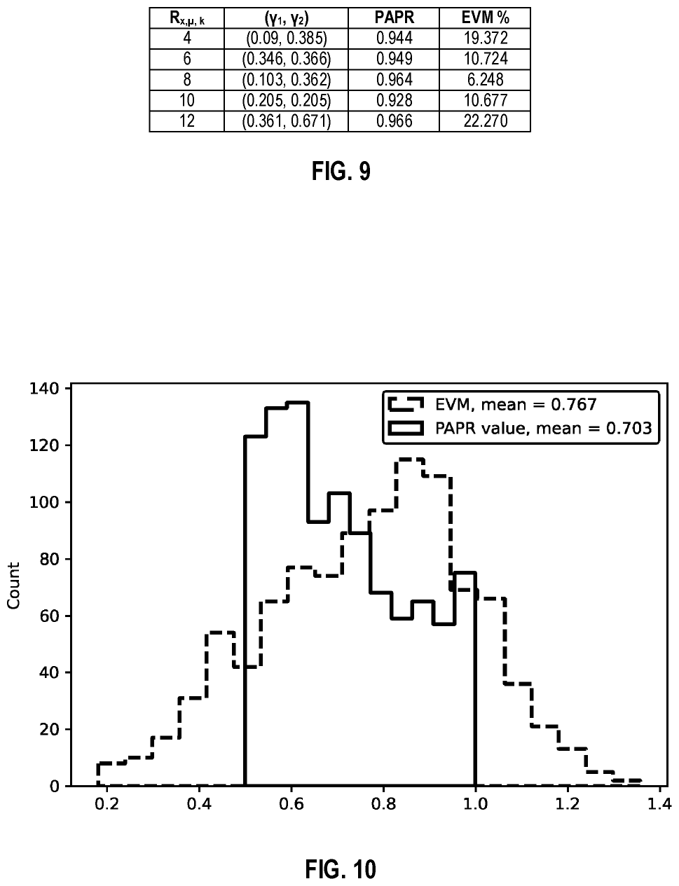

The problem now has 2 penalties, γ_{1,2} for the PAPR and the EVM parts of the problem, respectively, which need to be tuned per specific problem instance. Because the two penalties are likely codependent, optimal values of the pair are searched for jointly. To find a good pair (γ₁, γ₂), a simple grid-search was performed to locate a pair that minimizes PAPR while abiding the EVM constraint. The table of FIG. 9 shows the pairs found from the grid-search for varying resolutions, R_{x,μk}, which represents the number of binary variables used to approximate each real variable.

Interestingly, performance is improved only up to the R=8 resolution and worsens thereafter. Taking the penalty parameters for the resolution: R_{x,μ,k}, the same 2×2 MIMO problem was implemented on the quantum annealer by running 1000 anneals at 5 μs with a chain strength of 800. FIG. 10 illustrates the distribution of PAPR and EVM value obtained as a result.

The best results obtained a PAPR of 0.943 at an EVM of 7.218%. This is again competitive with classical SA results, although the EVM was minimized to a lower value of 6.248%. While this is lower than in the QA case, both are acceptable according to 3GPP requirements.

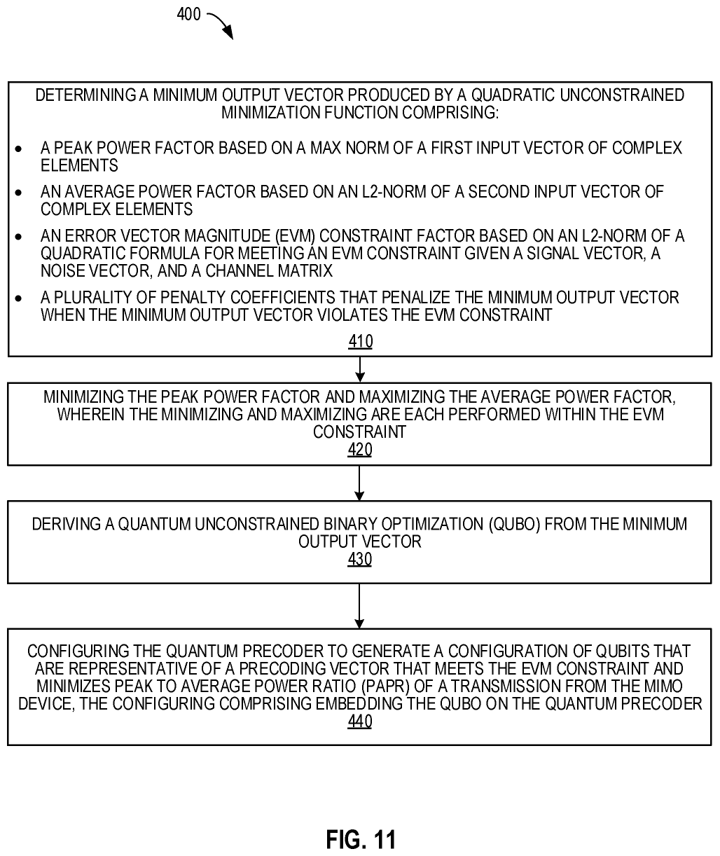

In view of the above, FIG. 11 illustrates an example method 400 implemented by a computing device, e.g., a MIMO device 200 as discussed above. The method 400 comprises determining a minimum output vector produced by a quadratic unconstrained minimization function (block 410). The quadratic unconstrained minimization function comprises a peak power factor based on a max norm of a first input vector of complex elements. The quadratic unconstrained minimization function further comprises an average power factor based on an L2-norm of a second input vector of complex elements. The quadratic unconstrained minimization function further comprises an EVM constraint factor based on an L2-norm of a quadratic formula for meeting an EVM constraint given a signal vector, a noise vector, and a channel matrix. The quadratic unconstrained minimization function further comprises a plurality of penalty coefficients that penalize the minimum output vector when the minimum output vector violates the EVM constraint. The method 400 further comprises minimizing the peak power factor and maximizing the average power factor (block 420). The minimizing and maximizing are each performed within the EVM constraint. The method 400 further comprises deriving a QUBO from the minimum output vector (block 430). The method 400 further comprises configuring the quantum precoder to generate a configuration of qubits that are representative of a precoding vector that meets the EVM constraint and minimizes PAPR of a transmission from the MIMO device 200 (block 440). The configuring comprises embedding the QUBO on the quantum precoder.

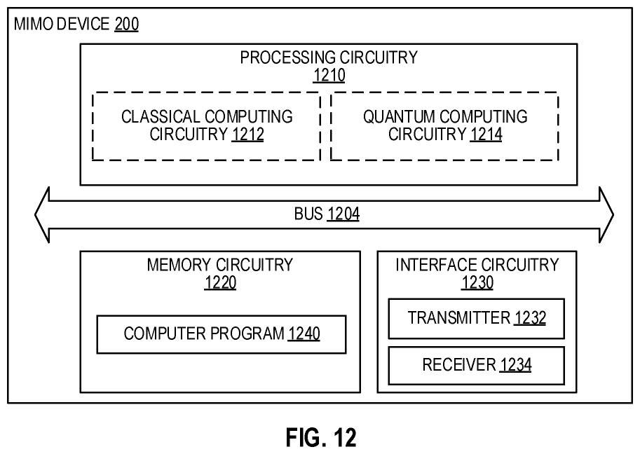

Other embodiments of the present disclosure include a MIMO device 200 implemented as schematically illustrated in the example of FIG. 12. The example MIMO device 200 of FIG. 12 comprises processing circuitry 1010, memory circuitry 1020, and interface circuitry 1030. The processing circuitry 1010 is communicatively coupled to the memory circuitry 1020 and the interface circuitry 1030, e.g., via a bus 1004.

The processing circuitry 1010 may comprise classical computing circuitry 1212 and/or quantum computing circuitry 1214. The quantum computing circuitry 1214 may be configured to operate as a quantum precoder 210 as described above, for example. In one particular example, the quantum computing circuitry 1214 may comprise a general gate model quantum computing device configured to operate one or more quantum circuits. According to various embodiments, the quantum computing circuitry 1214 may be configured to perform Quantum Annealing, Simulated Annealing, a Quantum Approximate Optimization Algorithm (QAOA), and/or other quantum-enabled operation.

The classical computing circuitry 1012 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. Generally speaking, the processing circuitry 1010 may be programmable hardware capable of executing software instructions stored, e.g., as a machine-readable computer program 1040 in the memory circuitry 1020.

The memory circuitry 1020 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 1030 may be a controller hub configured to control the input and output (I/O) data paths of the MIMO device 200. Such I/O data paths may include data paths for exchanging signals via a radio channel 240. The interface circuitry 1030 may be implemented as a unitary physical component, or as a plurality of physical components that are contiguously or separately arranged, any of which may be communicatively coupled to any other, or may communicate with any other via the processing circuitry 1010. For example, the interface circuitry 1030 may comprise a transmitter 1032 configured to send wireless communication signals and a receiver 1034 configured to receive wireless communication signals.

According to particular embodiments, the interface circuitry 1030 is configured to transmit signals wirelessly via a radio channel 240. The processing circuitry 1010 is configured to determine a minimum output vector produced by a quadratic unconstrained minimization function. The quadratic unconstrained minimization function comprises a peak power factor based on a max norm of a first input vector of complex elements. The quadratic unconstrained minimization function further comprises an average power factor based on an L2-norm of a second input vector of complex elements. The quadratic unconstrained minimization function further comprises an EVM constraint factor based on an L2-norm of a quadratic formula for meeting an EVM constraint given a signal vector, a noise vector, and a channel matrix. The quadratic unconstrained minimization function further comprises a plurality of penalty coefficients that penalize the minimum output vector when the minimum output vector violates the EVM constraint. The processing circuitry is further configured to minimize the peak power factor and maximize the average power factor. The minimizing and maximizing are each performed within the EVM constraint. The processing circuitry is further configured to derive a QUBO from the minimum output vector. The processing circuitry is further configured to configure the quantum precoder to generate a configuration of qubits that are representative of a precoding vector that meets the EVM constraint and minimizes PAPR of a transmission from the MIMO device. The configuring comprises embedding the QUBO on the quantum precoder.

Other embodiments include a computer program 1040 comprising instructions that, when executed on processing circuitry 1010 of a MIMO device 200, cause the MIMO device 200 to carry out the method 400.

Yet other embodiments include a carrier containing the computer program 1040. The carrier is one of an electronic signal, optical signal, radio signal, or computer readable storage medium.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-15. (canceled)

16. A method of configuring a quantum precoder of a Multiple-Input Multiple Output (MIMO) device, the method comprising:
determining a minimum output vector produced by a quadratic unconstrained minimization function comprising:
a peak power factor based on a max norm of a first input vector of complex elements;
an average power factor based on an L2-norm of a second input vector of complex elements;
an Error Vector Magnitude (EVM) constraint factor based on an L2-norm of a quadratic formula for meeting an EVM constraint given a signal vector, a noise vector, and a channel matrix; and
a plurality of penalty coefficients that penalize the minimum output vector when the minimum output vector violates the EVM constraint;
minimizing the peak power factor and maximizing the average power factor, wherein the minimizing and maximizing are each performed within the EVM constraint;
deriving a Quantum Unconstrained Binary Optimization (QUBO) from the minimum output vector; and
configuring the quantum precoder to generate a configuration of qubits that are representative of a precoding vector that meets the EVM constraint and minimizes Peak to Average Power Ratio (PAPR) of a transmission from the MIMO device, the configuring comprising embedding the QUBO on the quantum precoder.

17. The method of claim 16, wherein minimizing the peak power factor comprises determining a maximum real value that is lesser than each element of the first input vector of complex elements and increasing the maximum real value to penalize values of the peak power factor that are less than each element of the first input vector.

18. The method of claim 16, wherein maximizing the average power factor comprises determining a minimum real value based on an L2 norm of the second input vector.

19. The method of claim 16, wherein deriving the QUBO from the minimum output vector comprises, responsive to minimizing the peak power factor and maximizing the average power factor, introducing a further penalty coefficient to the quadratic unconstrained minimization function, wherein the further penalty coefficient penalizes values of the peak power factor that introduce one or more terms of higher order than quadratic.

20. The method of claim 16, wherein the quantum precoder is comprised within a general gate model quantum computing device of the MIMO device.

21. The method of claim 16, wherein embedding the QUBO on the quantum precoder comprises embedding the QUBO through quantum annealing.

22. The method of claim 16, wherein generating the configuration of qubits comprises processing the QUBO using a Quantum Approximate Optimization Algorithm (QAOA) to determine the configuration of qubits.

23. The method of claim 16, further comprising:
reading the configuration of qubits out of the quantum precoder; and
determining the precoding vector by translating the qubits to real values and converting the real values to respective complex elements of the precoding vector.

24. The method of claim 16, further comprising transmitting the transmission via an antenna array of the MIMO device using the precoding vector.

25. The method of claim 16, wherein the plurality of penalty coefficients comprises, for each of the peak power factor, the average power factor, and the EVM constraint factor, a respective penalty coefficient such that each of the peak power factor, average power factor, and EVM constraint is individually tunable.

26. The method of claim 16, obtaining the quadratic unconstrained minimization function by applying a quadratic loss function to a constrained PAPR objective function.

27. A Multiple-Input Multiple Output (MIMO) device comprising:
processing circuitry and memory circuitry storing instructions executable by the processing circuitry whereby the MIMO device is configured to:
determine a minimum output vector produced by a quadratic unconstrained minimization function comprising:
a peak power factor based on a max norm of a first input vector of complex elements;
an average power factor based on an L2-norm of a second input vector of complex elements;
an Error Vector Magnitude (EVM) constraint factor based on an L2-norm of a quadratic formula for meeting an EVM constraint given a signal vector, a noise vector, and a channel matrix; and
a plurality of penalty coefficients that penalize the minimum output vector when the minimum output vector violates the EVM constraint;
minimize the peak power factor and maximize the average power factor, wherein the minimizing and maximizing are each performed within the EVM constraint;
derive a Quantum Unconstrained Binary Optimization (QUBO) from the minimum output vector; and
configure a quantum precoder to generate a configuration of qubits that are representative of a precoding vector that meets the EVM constraint and minimizes Peak to Average Power Ratio (PAPR) of a transmission from the MIMO device, wherein to configure the quantum precoder, the MIMO device is further configured to embed the QUBO on the quantum precoder.

28. The MIMO device of claim 27, wherein to minimize the peak power factor the MIMO device is configured to determine a maximum real value that is lesser than each element of the first input vector of complex elements and increasing the maximum real value to penalize values of the peak power factor that are less than each element of the first input vector.

29. The MIMO device of claim 27, wherein to maximize the average power factor the MIMO device is configured to determine a minimum real value based on an L2 norm of the second input vector.

30. The MIMO device of claim 27, wherein to derive the QUBO from the minimum output vector the MIMO device is configured to, responsive to minimizing the peak power factor and maximizing the average power factor, introduce a further penalty coefficient to the quadratic unconstrained minimization function, wherein the further penalty coefficient penalizes values of the peak power factor that introduce one or more terms of higher order than quadratic.

31. The MIMO device of claim 27, wherein the quantum precoder is comprised within a general gate model quantum computing device of the MIMO device.

32. The MIMO device of claim 27, wherein to generate the configuration of qubits the MIMO device is configured to process the QUBO using a Quantum Approximate Optimization Algorithm (QAOA) to determine the configuration of qubits.

33. The MIMO device of claim 27, further configured to:
read the configuration of qubits out of the quantum precoder; and
determine the precoding vector by translating the qubits to real values and converting the real values to respective complex elements of the precoding vector.

34. The MIMO device of claim 27, further configured to transmit the transmission via an antenna array of the MIMO device using the precoding vector.

35. A computer program product comprising a computer program, the computer program comprising instructions which, when executed on processing circuitry of a MIMO device, cause the processing circuitry to:
determine a minimum output vector produced by a quadratic unconstrained minimization function comprising:
a peak power factor based on a max norm of a first input vector of complex elements;
an average power factor based on an L2-norm of a second input vector of complex elements;
an Error Vector Magnitude (EVM) constraint factor based on an L2-norm of a quadratic formula for meeting an EVM constraint given a signal vector, a noise vector, and a channel matrix; and
a plurality of penalty coefficients that penalize the minimum output vector when the minimum output vector violates the EVM constraint;
minimize the peak power factor and maximizing the average power factor, wherein the minimizing and maximizing are each performed within the EVM constraint;
derive a Quantum Unconstrained Binary Optimization (QUBO) from the minimum output vector; and
configure the quantum precoder to generate a configuration of qubits that are representative of a precoding vector that meets the EVM constraint and minimizes Peak to Average Power Ratio (PAPR) of a transmission from the MIMO device, the configuring comprising embedding the QUBO on the quantum precoder.
